(19) United States
(12) Patent Application Publication
(10) Pub. No.: US 2014/0351907 A1
(43) Pub. Date: Nov. 27, 2014

(54) CREDENTIAL AUTHENTICATION SYSTEM AND METHODS OF PERFORMING THE SAME

(71) Applicant: Personal Credentialing Group, LLC, Fort Myers, FL (US)

(72) Inventor: Randy A. Noble, Fort Myers, FL (US)

(73) Assignee: Personal Credentialing Group, LLC, Fort Myers, FL (US)

(21) Appl. No.: 14/283,026

(22) Filed: May 20, 2014

Related U.S. Application Data
(60) Provisional application No. 61/825,585, filed on May 21, 2013.

(51) Int. Cl. H04L 29/06

(52) U.S. Cl. CPC H04L 63/08
USPC 726/6

(57) ABSTRACT

A personal credentialing system including an information gathering unit that gathers information from a subscriber. A credential analysis unit configured to gather additional information pertaining to the subscriber based on the information gathered by the information gathering unit, store the additional information in a storage unit, categorize the additional information based on predefined criteria, assign an indicator to the additional information based on categorization of the additional information, and stores the additional information and indicators. A credential access unit that receives requests for access to view the indicators and stored additional information from a third party. A credential display unit that displays the indicators and stored additional information after the credential access unit authorizes a request to view the stored additional information. Methods of verifying a person's credentials, conveying personal credential information, and preventing fraudulent on-line postings.

### CROSS-REFERENCE TO RELATED APPLICATION

This application claims the benefit of U.S. Provisional Application No. 61/825,585 filed May 21, 2013.

### BACKGROUND OF THE INVENTION

The Internet has become a powerful tool for meeting and engaging others for both business and social endeavors. Internet web pages allow users to post information about themselves for others to view. However, a large amount of the information posted by users is not authenticated. Further, the use of digital information makes posting incorrect or fraudulent information easier. In social media, such as online dating web sites, a user may interact with another person online before meeting in person. Much of the information exchanged by the user and the other person is unverified. This is also the case for professional social media such as LinkedIn.

Typically, to verify a user's information, a user must gain authorization to run a credential check from the person being researched. After authentication is obtained, the user may order a report from a background investigation service that will provide a report to the user detailing information on the other person. Using current technology, the person being investigated has little control over the information included in the report. Further, the generated report typically includes generic information on the person being investigated.

Accordingly, a system is needed that will simplify the verification process by allowing a user to post verified background information to other users.

### BRIEF SUMMARY OF THE INVENTION

One embodiment of the present invention includes a personal credentialing system that may have an information gathering unit that gathers information from a subscriber. The system may also include a credential analysis unit that may be configured to gather additional information pertaining to the subscriber based on the information gathered by the information gathering unit, store the additional information in a storage unit, categorize the additional information based on predefined criteria, assign an indicator to the additional information based on categorization of the additional information, and store the additional information and indicators. A credential access unit may receive requests for access to view the indicators and stored additional information from a third party. A credential display unit may display the indicators and stored additional information after the credential access unit authorizes a request to view the stored additional information.

In another embodiment, the stored additional information may be prevented from being displayed on a web page after the expiration of a predetermined event. In another embodiment, the subscriber may select the information displayed on the web page based on the third party request. In another embodiment, the predetermined event may be the elapse of a predetermined time period. In another embodiment, the predetermined event may be the viewing of the web page by the third party.

In another embodiment, the credential analysis unit may categorize the additional information as compliant or non-compliant with applicable government regulations on personal data. For example, in the United States, the additional information may be categorized as Fair Credit Reporting Act (“FCRA”) compliant or non-FCRA compliant. In another embodiment, the credential access unit may transmit a request to authorize the viewing of the stored additional information to the subscriber. In another embodiment, the credential access unit may grant access or deny access to the stored additional information based on the subscriber's response to the transmitted request. In another embodiment, the request may include a listing of the stored additional information, and the response to the request may include a listing of information the third party is authorized to view. In another embodiment, the indicator may be a color coded emblem.

Another embodiment of the present invention includes a system of conveying personal credential information stored on a device having a memory and a processor. The device may have a program executed in the memory that performs the steps of gathering information from a subscriber by an information gathering unit, gathering by a credential analysis unit additional information pertaining to the subscriber based on the information gathered by the information gathering unit, storing by the credential analysis unit the additional information in a storage unit in the memory, categorizing by the credential analysis unit the additional information based on predefined criteria, assigning by the credential analysis unit an indicator to the additional information based on categorization of the additional information, and scoring by the credential analysis unit the additional information and indicators, receiving requests by a credential access unit for access to view the indicators and stored additional information from a third party, and displaying by a credential display unit the indicators and stored addition information after the credential access unit authorizes a request to view the stored additional information.

In another embodiment, the stored additional information may be prevented from being displayed on a web page after the expiration of a predetermined event. In another embodiment, the subscriber may select the information displayed on the web page based on the third party request. In another embodiment, the predetermined event may be the lapse of a predetermined time period. In another embodiment, the predetermined event may be the viewing of the web page by the third party. In another embodiment, the credential analysis unit may categorize the additional information as FCRA compliant or non-FCRA compliant. In another embodiment, the credential access unit may transmit a request to authorize the viewing of the stored additional information to the subscriber. In another embodiment, the credential access unit may grant access or deny access to the stored additional information based on the subscriber's response to the transmitted request. In another embodiment, the request may include a listing of the stored additional information, and the response to the request includes a listing of information the third party is authorized to view. In another embodiment, the indicator may be a color coded emblem.

Another embodiment of the invention includes a method for verifying an individual's personal credentials that includes gathering initial information from a subscriber; gathering additional information pertaining to the subscriber based on the initial information, storing the additional information in a storage unit, categorizing the additional information based on predefined criteria, assigning an indicator to the additional information based on the categorization and representative value of the additional information, and storing the additional information and indicators in the storage unit; receiving a request for access to view the indicators and stored additional information from a third party; authorizing a request to view the stored additional information; and displaying the indicators and stored additional information on a web page.

Another embodiment of the invention includes a method of conveying personal credential information stored on a device having a memory and a processor. The processor executes a program stored in the memory to perform the steps of: gathering initial information from a subscriber; gathering additional information pertaining to the subscriber based on the initial information, storing the additional information in a storage unit in the memory, categorizing the additional information based on predefined criteria, assigning an indicator to the additional information based on the categorization of the additional information, storing the additional information and indicators; receiving a request to view the indicators and stored additional information from a third party; and displaying the indicators and stored additional information on a web page after authorizing a request to view the stored additional information.

Yet another aspect of the invention includes a method for preventing fraudulent online postings by a person. The identity and credentials of the person are identified by executing with a processor a program stored in a computer memory the following: (a) gathering initial information about the person; (b) gathering additional information pertaining to the person based on the initial information; (c) categorizing the additional information based on predefined criteria; and (d) assigning a score to the additional information based on the categorization of the additional information. Thereafter, the person is permitted to post the information if the score exceeds a predefined threshold value.

### BRIEF DESCRIPTION OF THE DRAWINGS

Details of the present invention, including non-limiting benefits and advantages, will become more readily apparent to those of ordinary skill in the relevant art after reviewing the following detailed description and accompanying drawings, wherein:

FIG. 1 depicts a block diagram of a Personal Credentialing System suitable for use with the methods and systems consistent with the present invention;

FIG. 2 shows a more detailed depiction of a computer of FIG. 1;

FIG. 3 shows a more detailed depiction of additional computers of FIG. 1;

FIG. 4 depicts an illustrative example of the operation of the Personal Credentialing System of FIG. 1;

FIG. 5 depicts a schematic representation of the process performed by the credential analysis unit of FIG. 1 after receiving a subscriber report;

FIG. 6 depicts a schematic representation of the credential analysis unit of FIG. 1 generating ratings based on the report information;

FIG. 7 depicts a schematic representation of the credential access unit processing a request from a third party to view a subscriber's credential information;

FIG. 8 depicts one embodiment of an emblem 800 that is consistent with the present invention; and

FIG. 9 depicts a schematic representation of a process used to generate an emblem.

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

Described herein is a system for rating the credentials of an individual based on a plurality of rating factors. The system gathers information from a user, analyzes the information based on predefined criteria, rates the user based on the results of the analysis, and posts the rating to a viewable web page based on a request to view the rating from another party. The system allows third parties to view the gathered credential information via a web page created for the third party user that is available for viewing for a predetermined period of time. The third party user may be a company, individual, educational institution, social media web site or any other party interested in viewing credential information.

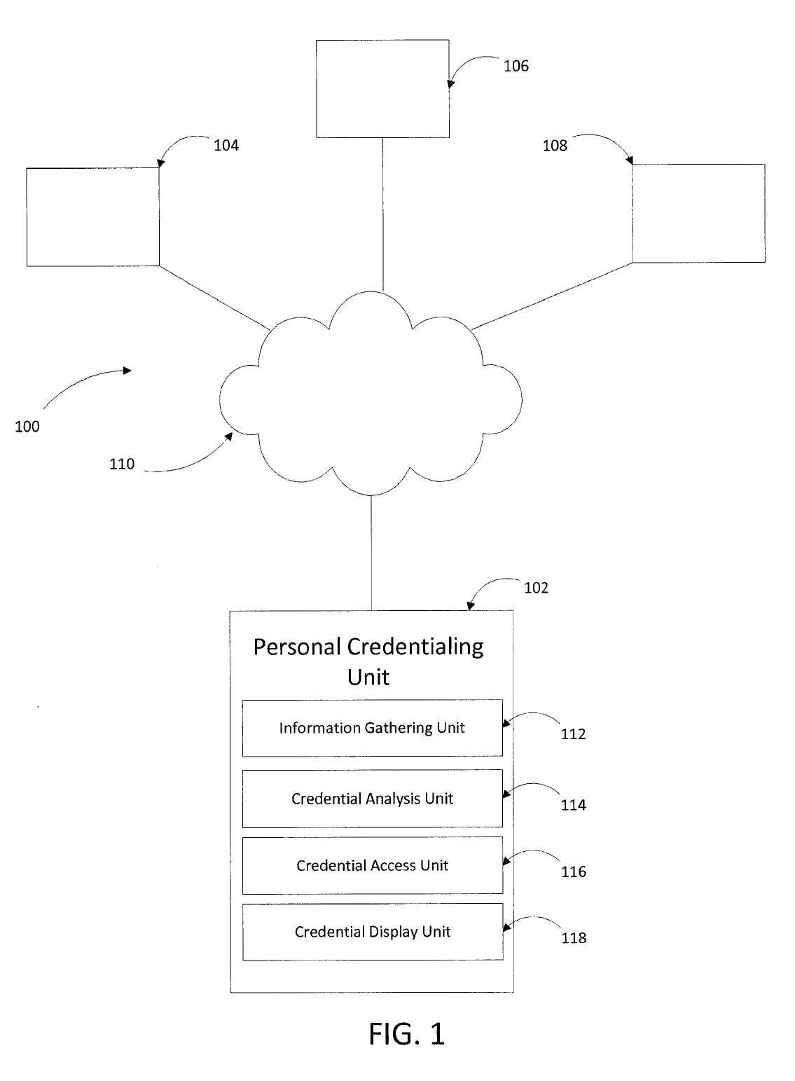

FIG. 1 depicts a block diagram of a Personal Credentialing System (“PCS”) 100 suitable for use with the methods and systems consistent with the present invention. The PCS 100 comprises a plurality of computers 102, 104, 106 and 108 connected via a network 110. The network 110 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104, 106 and 108 shown in FIG. 1 is connected to the network 110 via a suitable communication link, such as a dedicated communication line or a wireless communication link.

In an illustrative example, computer 102 serves as a Personal Credentialing Unit (“PCU”) that includes an information gathering unit 112, a credential analysis unit 114, a credential access unit 116 and a credential display unit 118. The number of computers and the network configuration shown in FIG. 1 are merely an illustrative example. One having skill in the art will appreciate that the PCS 100 may include a different number of computers and networks. For example, computer 102 may include the information gathering unit 112 as well as one or more of the credential analysis unit 114 and credential display unit 118. Further, the credential access unit 116 may reside on a different computer than computer 102.

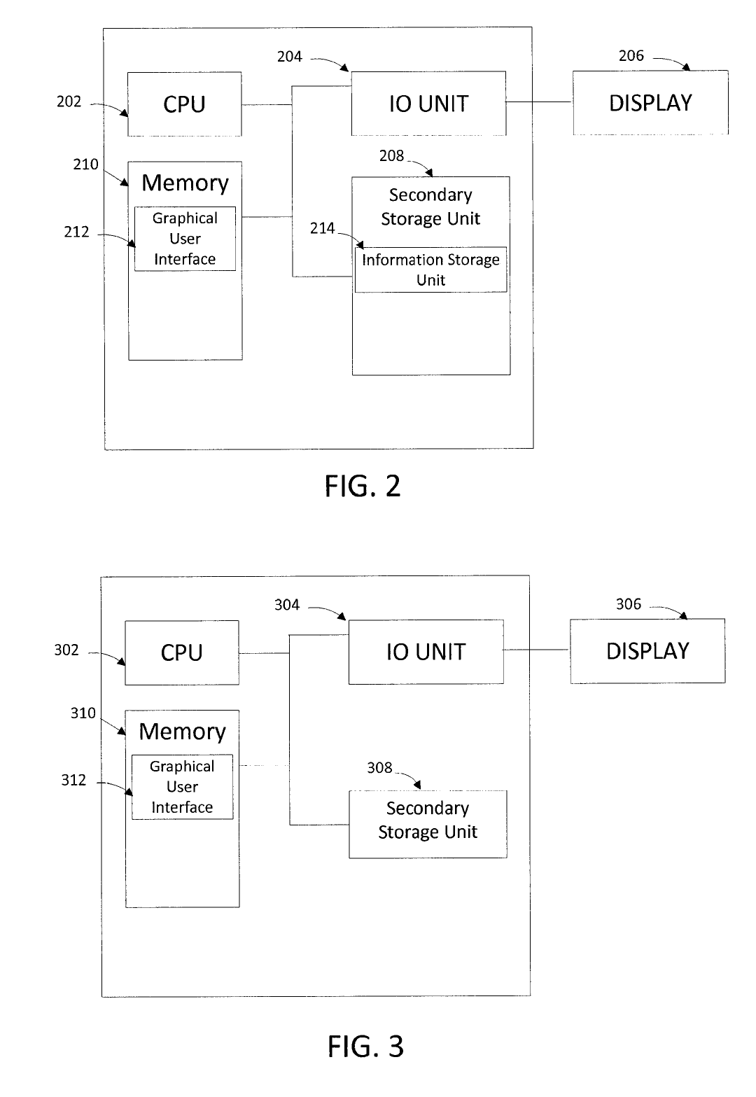

FIG. 2 shows a more detailed depiction of the computer 102. The computer 102 comprises a central processing unit (CPU) 202, an input output (IO) unit 204, a display device 206 communicatively coupled to the IO Unit 204, a secondary storage device 208, and a memory 210. The computer 202 may further comprise standard input devices such as a keyboard, a mouse, a digitizer, or a speech processing means (each not illustrated).

The computer 102's memory 210 includes a Graphical User Interface (“GUI”) 212 that is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer, Google Chrome or any other commercially available HTML viewing software. The secondary storage unit 208 may include an information storage unit 214. The information storage unit may be a relational database such as, but no limited to, Microsoft's SQL, Oracle or any other database.

FIG. 3 shows a more detailed depiction of the computers 104, 106 and 108. Each computer 104, 106 and 108 comprises a central processing unit (CPU) 302, an input output (IO) unit 304, a display device 306 communicatively coupled to the IO Unit 304, a secondary storage device 308, and a memory 310. Each computer 104, 106 and 108 may further comprise standard input devices such as a keyboard, a mouse, a digitizer, or a speech processing means (each not illustrated).

Each computer 104, 106 and 108's memory 310 includes a GUI 312 which is used to gather information from a user via the display device 306 and IO unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present invention, the GUI 312 is displayed using commercially available HTML viewing software such as, but not limited to, Microsoft Internet Explorer, Google Chrome or any other commercially available HTML viewing software. The computers 102, 104, 106 or 108 may be compliant with the standards incorporated into the Fair Credit Reporting Act (“FCRA”).

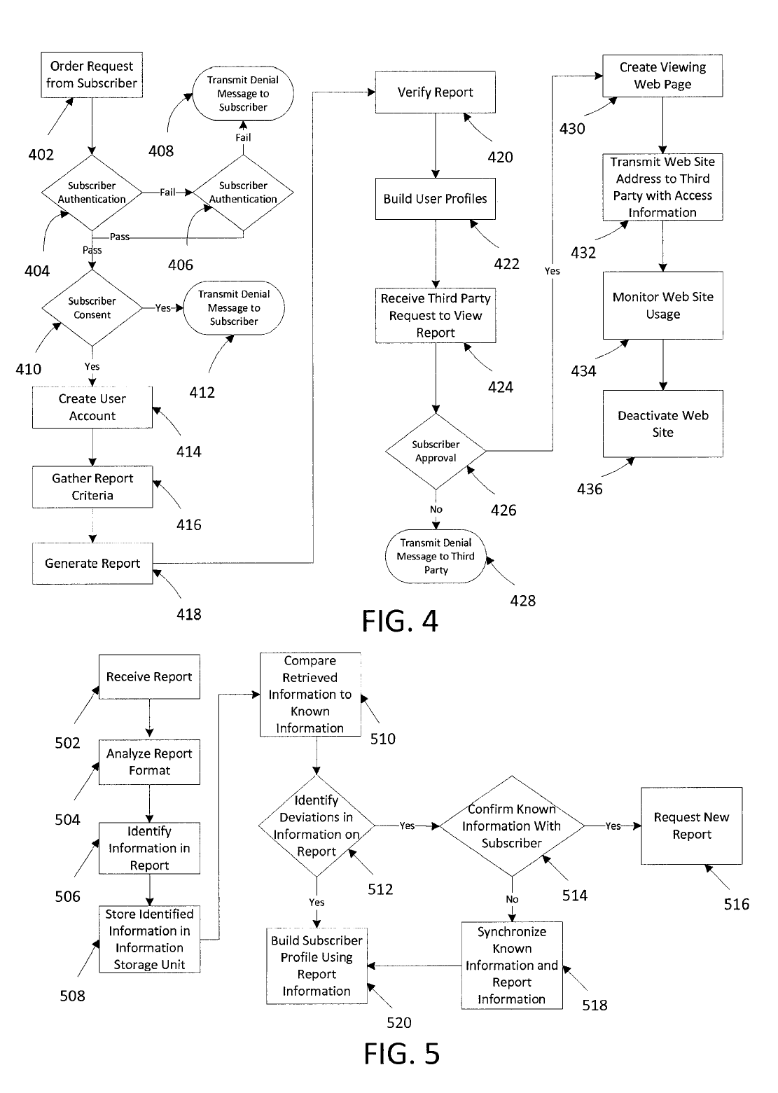

FIG. 4 depicts an illustrative example of the operation of the PCS 100. In step 402, a request to order a credential report is received by the information gathering unit 112. The request may be received via a web site, e-mail, SMS message, telephone call or by any other method used to order a product or service. The request may be initiated directly by a subscriber via the PCS 100 or via a third party web site such as a social media web site. The request may include a listing of the specific types of credential information to include in a credential report generated by an external source. The external source may be a FCRA report generation device connected to the PCS 100 via the network 110.

In generating the order, the subscriber may include information such as the subscriber's social security number, home address, telephone number, date of birth, or any other information that can identify the subscriber. In step 404, the information gathering unit 112 gathers additional information from the subscriber to authenticate the subscriber's identity. In one embodiment, the information gathering unit 112 may search a database for historic information on a user such as a previously listed home address, previous banks the user has held accounts or any other information known only to the subscriber. As an illustrative example, the information gathering unit 112 may prompt the subscriber to identify a previous home address from a list of home addresses to authenticate the subscriber's identity. In one embodiment, the information gathering unit 112 may transmit the subscriber's information to a third party (such as a FCRA service provider) for authentication. The information gathering unit 112 may authenticate the subscriber's identity using any other known methods of user authentication including the use of authentication certificates.

In step 406, if the subscriber cannot be authenticated, a second authentication is performed. The second authentication may include gathering additional information from the subscriber to verify the identity of the subscriber. In step 408, if the subscriber cannot be authenticated, the information gathering unit 112 transmits a message to the subscriber stating that the subscriber was not authenticated and the process ends. If the information gathering unit 112 authenticates the subscriber, the process moves to step 410. In step 410, the information gathering unit 112 presents a consent agreement to the subscriber for the subscriber's approval. The consent agreement includes a confirmation that the subscriber authorizes a search of private and public information concerning the subscriber. In step 412, if the subscriber does not consent to the search, a denial message is transmitted to the subscriber and the process ends. If the subscriber consents to the search, the process moves to step 414.

In step 414, the information gathering unit 112 creates a user account in the information storage unit 214. The user account may store subscriber information such as the name, address, phone number, sex, age, e-mail address, social security number, or any other information that can be used to identify the subscriber. In step 416, the information gathering unit 112 gathers search information concerning the subscriber. The search information may include a list of subscriber information to locate including alias, addresses where the subscriber lives or has previously lived, subscriber date of birth confirmation, subscriber registrations on sex offender registries, the subscriber's criminal history, the subscriber's education records, the subscribers employment history, the subscriber's licenses and registrations or any other information for the subscriber. The search information may be obtained from publically available web pages, private databases, external FCRA search devices or from any other repository of search information.

The information gathering unit 112 may transmit a request for specific information from each location having access to the search information. The information gathering unit 112 may also transmit multiple requests for information from multiple locations. Consistent with this embodiment, the information gathering unit 112 may connect with the external source via the network 110 and transmit the subscriber's information and the search information to the external source. The external source may perform the requested search and transmit a complete listing of the requested information to the information gathering unit 112. The listing may be transmitted using any known method of securely transmitting information across a network. The listing may be transmitted in any format including, a text document, e-mail, database object or any other known data format. In step 418, the information gathering unit 112 generates a report based on the gathered information. In generating the report, the information gathering unit 112 consolidates all gathered information into a single format that is stored in the memory 210 of the PCS 100. The information may be stored in any format including text, graphical, binary or any other digital format.

In step 420, the credential analysis unit 114 may analyze the information in the report to confirm the report is correct. The credential analysis unit 114 may confirm the name, social security address, phone number, e-mail address of the subscriber or any other information in the report. In step 422, the credential analysis unit 114 builds a subscriber profile in the information storage unit 214 by parsing the report and storing the report information in the information storage unit 214. The information storage unit 214 may be a database such as Microsoft SQL, Oracle or any other database. The credential analysis unit 114 may store subscriber information in tables in the database for retrieval at a later time. The credential analysis unit 114 may categorize the report information into at least one of a plurality of predetermined categories. The credential analysis unit 114 may categorize the report information based on keywords identified in the report information. The credential analysis unit 114 may also analyze the report information to generate a rating of the subscriber for each category of information included in the report. As an illustrative example, the credential analysis unit 114 may analyze the credit history of the subscriber and provide a ranking indicator of the subscriber's credit history. The ranking indicator may be a logo, a color, a word or any combination of colors, logos and words. The ranking indicator for each category is stored in the information storage unit 214.

In step 424, the information gathering unit 112 may receive a request from a third party to view credential information on a subscriber. In step 426, the information gathering unit 112 notifies the subscriber that a request to view their information has been received. The information gathering unit 112 may notify the user by transmitting an e-mail to the subscriber listing the name or identifying information of the third party requesting the information or by any other method of notification. In response to the notification, the subscriber may respond authorizing the release of information to the third party. In another embodiment, the subscriber may respond with a listing of information that the third party is authorized to view. In another embodiment, the subscriber may log into a web page stored on the PCS 100 that allows the subscriber to select information from a list of information for viewing by the third party.

If the subscriber refuses to release the information, the information gathering unit 112 transmits a request denied message to the third party and the process ends in step 428. The request denied message may be an e-mail message, SMS message, telephone call or any other notification method. In step 430, if the subscriber approves the release of information, the credential access unit 116 creates a viewing account for the third party and a viewing web page showing the subscriber information the third party is authorized to view. The credential access unit 116 may allow the third party to view or download the information a predefined number of times or over a predetermined time period. The viewing account includes a user name and a password that allows the third party to access the web page for viewing. Authentication of the user name and password may be accomplished using any known user name and password authentication method.

In step 432, the credential display unit 118 transmits the uniform resource locator (“URL”) of the web page on the PCS 100 along with a unique user name and password for the third party to connect and view the subscriber's information. The credential access unit 116 may generate separate web pages for each third party request. Accordingly, each third party request may generate a new unique URL and a new unique user name and password. In step 434, the credential access unit 116 monitors the access to the web page and provides analytical information to the subscriber detailing the number of times the page was accessed and the information that was viewed by the third party. Further, the credential access unit 116 removes the web page from viewing after a predetermined number of log ins by the third party or after a predetermined amount of time has elapsed in step 436. In removing the web page, the software code, such as HTML code, may be permanently deleted from the computer serving the web page. Further, the user name and password used to access the web page are deactivated by the device authenticating the user name and password.

FIG. 5 depicts a schematic representation of the process performed by the credential analysis unit 114 after receiving a subscriber report. In step 502, the credential analysis unit 114 receives the subscriber report from the external source. The external source may be a FCRA compliant service provider. In step 504, the credential analysis unit 114 analyzes the format of the report. The report may be received as a text document, an XML file, an image, a database file, a spreadsheet or any other data format. The report may include a listing identifying where the information resides in the report. As an illustrative example, the report may include indicators positioned adjacent to information in the report. The indicators may be used to identifying where specific information resides in the report, and to categorize the information in the report as will be discussed herein.

In step 506, the credential analysis unit 114 may identify the location of the requested information in the report. The credential analysis unit 114 may use any known method of identifying information in the report including, but not limited to, optical code recognition or character recognition. In step 508, the credential analysis unit 114 stores each piece of identified information in the information storage unit 214. The information may be stored in the information storage unit 214 as database table entries that are logically related to the subscriber account. In step 510, the credential analysis unit 114 may compare the retrieved information from the report to known information stored in the information storage unit 214. As an illustrative example, the credential analysis unit 114 may compare the name, social security number, phone number, e-mail address, criminal history and credit values associated with the subscriber with the information extracted from the report to confirm the report includes correct information. The credential analysis unit 214 may also confirm the information in the report is compliant with the FCRA.

In step 512, the credential analysis unit 114 determines if the known information stored in the information storage unit 214 deviates from the report information. In step 514, if the information deviates from the stored information, the credential analysis unit 114 transmits a request to the subscriber to confirm the stored information. If the subscriber confirms the report information is incorrect, or edits or adds non-FCRA personal information, the credential analysis unit 116 synchronizes the known information with the report information and the process moves to step 518. If the subscriber confirms the known information is correct, the credential analysis unit 114 generates a new report or requests an updated report from the external source or from another external source in step 516.

In step 520 the credential analysis unit 114 creates a subscriber profile in the information storage unit 214 using the report information. In creating the subscriber profile, the credential analysis unit 114 may categorize each unit of information from the report by relating the information to one or more categories stored in the information storage unit 214. The categories may include, but are not limited to, previously used names or aliases, credit history, criminal history, medical history, employment history, education, residence history, licenses, criminal registries, professional registries, or any other information relating to the subscriber that is included in the report. The subscriber profile includes the known information on the subscriber and the information from the report with each piece of information in the report being categorized. Further, the credential analysis unit 114 may further categorize each piece of information as being FCRA or non-FCRA information.

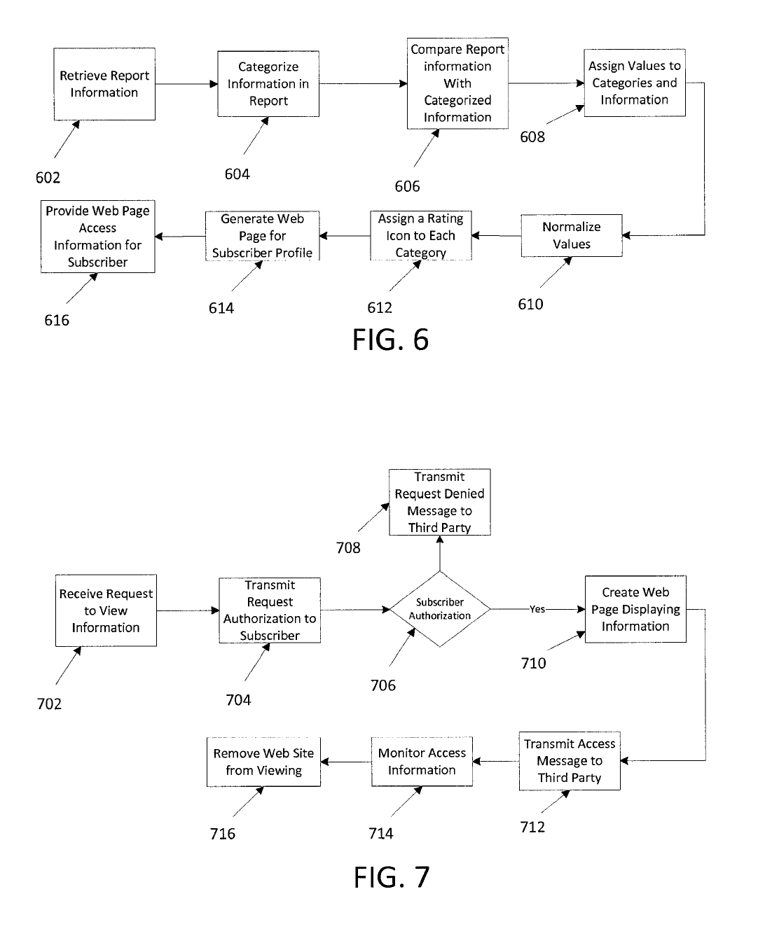

FIG. 6 depicts a schematic representation of the credential analysis unit 114 generating ratings based on the report information. In step 602, the credential analysis unit 114 retrieves the report information from the subscriber's profile stored in the information storage unit 214. The credential analysis unit 114 may retrieve all information in the subscriber's profile related to a specific category. The credential analysis unit 114 may also retrieve specific pieces of information from the subscriber's profile, such as the subscriber's credit score. In step 604, the credential analysis unit 114 retrieves a plurality of predetermined values relating to the category or piece of information from the information storage unit 214. The predetermined values may represent different values for each piece of information in the subscriber's profile. As an illustrative example, one predetermined value may represent a range of credit scores representing excellent, good, and poor credit scores.

In step 606, the credential analysis unit 114 compares the predetermined values with the subscriber information. As an illustrative example, the credential analysis unit 114 may compare the subscriber's credit score with the values in each credit score range to determine a rating for the user's credit score. As another illustrative example, the credential analysis unit 114 may identify the type of debt associated with the subscriber's credit score and compare the subscriber's debt with predetermined debt categories from the information storage unit 214 to rate the subscriber's type of debt. As another illustrative example, the credential analysis unit 114 may compare the subscriber's criminal record with predetermined criminal record values to rate the criminal history of the subscriber.

In step 608, to rate each category or piece of information, the credential analysis unit 114 assigns a value to each piece of information in a category and then assigns an overall value to each category based on the total value assigned to each piece of information in the category. As an illustrative example, a subscriber may have a criminal history that includes a plurality of criminal events including a speeding ticket, a conviction for driving under the influence of alcohol and a conviction for assault. The credential analysis unit 114 may assign a value to each event based on a predetermined rating value for the event that is stored in the information storage unit 214. The credential analysis unit 114 may assign a low value such as 2 to the speeding ticket event while assigning a value of 6 to the driving under the influence event and a value of 8 to the assault event. After all the events in the criminal history category are assigned a value, the credential analysis unit totals each individual score and assigns an overall score of 16 to the subscriber's criminal history category.

In step 610, the credential analysis unit 114 may normalize the value assigned to each category in the subscriber's profile by applying a normalization factor. The normalization factor may be stored in the information storage unit 214 and related to each category or may be provided in the report information. The normalization factor represents an adjustment made to the information in the subscriber's profile to compensate for predetermined inconsistencies in the subscriber's profile. Returning to the previous example, the charge of assault may vary in severity based on the state where the crime occurred. The charge of assault may require extensive physical harm in one state while only requiring a simple touch in another state. To compensate for this discrepancy in the severity of the assault charge, the credential analysis unit 114 may apply a normalization factor to the value assigned to the assault charge based on the state where the event occurred. If the assault event occurred in a state having a low severity level, i.e. where a simple touch constitutes an assault, the credential analysis unit 114 may assign a normalization factor of 0.25 to the assault score to reduce the score to 2. If the assault event occurred in a state where the assault charge requires physical bodily harm, the credential analysis unit 114 may apply a normalization factor of 1.5 to increase the assault score to 12. While this example shows the normalization of a criminal history event, each event in the subscriber's profile may be normalized based on the analysis performed by the credential analysis unit 114.

Information on the different event types, such as a criminal event, credit event, employment event, etc. is stored in the information storage unit 214 and is related to each category. To analyze each event the credential analysis unit 114 may compare identifiers in each event to the identifiers related to each event type in the information storage unit 214. The identifiers may include, but are not limited to, words, numbers, codes, sentences, images or any other identifier that may be used to determine the type and severity of each event.

In step 612, the credential analysis unit 114 assigns a rating icon to each category in the subscriber's profile. The rating icon may be a color indicator such as, but not limited to, green for good, yellow for moderate and red for bad. The rating icon may also be an image such as a ribbon, banner or other emblem. In step 614, the credential access unit 116 and credential display unit 118 generate a web page to display the subscriber's profile. In generating the web page, the credential display unit 118 may register a unique domain name for the web page such that the web page resides on a device that is separate from the PCS 100. The credential display unit may also dedicate a specific URL to the web page that is associated with the subscriber's profile.

In step 616, the credential access unit 116 assigns a user name and password to the web page and transmits the user name and password for the web page to the subscriber. The credential access unit 116 may transmit the username and password via SMS message to a cellular device associated with the subscriber profile, e-mail, conventional mail, or by another other method capable of transmitting the username and password to the subscriber.

FIG. 7 depicts a schematic representation of the credential access unit 116 processing a request from a third party to view a subscriber's credential information. In step 702, the credential access unit 116 receives a request from a third party to view a subscriber's credential information. The credential access unit 116 may respond to the third party's request by requesting additional information from the third party, such as a listing of the information the third party is requesting to view. The request to the third party may be a message sent to the third party that redirects the third party to a web site having a request form listing information categories available in the subscriber's profile. In step 704, the credential access unit 116 transmits a notification message to the subscriber stating that a third party has requested access to view the subscriber's credentials. The message may include a link to a web site where the subscriber can select specific pieces of information or categories the third party may view. As an illustrative example, the subscriber may grant access for the third party to view all information in the subscriber's profile or only specific pieces of information. Alternatively, the subscriber may allow the third party to only view the ratings for a specific category without seeing the specific information associated with the category.

In step 706, the credential access unit 116 receives a message from the subscriber authorizing or denying the third party access to the subscriber's information. In step 708, if the subscriber denies the request, the credential access unit 116 transmits a message to the third party stating that the request for access to the subscriber's credential information has been denied. In step 710, if the subscriber has authorized the third party to access the subscriber's credentials, the credential access unit 116 and the credential display unit 118 create a web page displaying the authorized credential information of the subscriber. The web page is posted on a server connected to the Internet and is password protected to prevent any unauthorized access.

In step 712, the credential access unit 116 transmits a message to the third party that includes a link to the web page created in step 710 along with a user name and password to access the subscriber's credential information on the web page. The message may be transmitted by e-mail, a telephone call, an SMS message or any other method of communicating access information. In step 714, the credential access unit 116 monitors the identity of each device that accesses the web page along with the time and date of each access. The access information may be transmitted or displayed to the subscriber via a display on a web site accessible by the subscriber or via an e-mail message. In step 716, the web page is removed from viewing based on a predetermined removal event. The predetermined removal event may be the third party accessing the web page a predetermined number of times, the passage of a predetermined amount of time, or any other event defined by the subscriber that would trigger an expiration of the web page, username and password. After the removal event, the source code associated with the web page is permanently deleted from the server on which it resides and the URL address is deactivated.

The third party may be an individual or an external web site. In the case of an external web site, the subscriber may request that credential rating information be displayed on the external web site, or a link to the subscriber's credential information be displayed on the site. As an illustrative example, the subscriber may access a social media site such as LinkedIn, Facebook, Match.com or any other social media web site, and request that a link to the subscriber's credential information be displayed on the subscriber's social media page. The subscriber may select a button on their social media profile to display a link to the subscriber's credential page. When the subscriber clicks the request, the social media server sends a third party request to the credential access unit 116. The credential access unit 116 may transmit a message to the subscriber to confirm the request and gather the information to display on the web site or the information to transmit to the social media server. Upon approval by the subscriber, the credential display unit 116 creates a web page based on the subscriber's response to the message and transmits the URL of the web page to the social media server for display on the subscriber's social media page.

The external web site may restrict access to view user information based on the authentication level of each user. As an illustrative example, the web site may restrict non-authenticated users from viewing authenticated users information. Further, the social media web site may restrict non-authenticated users from viewing the authentication information of authenticated users. The subscriber's URL displayed on a third party web site may be identical for each separate third party web site. (this describes ‘portability’ of the URL & emblem)

The PCS 100 may include an administration web page that is accessible by the subscriber to manage the viewing, editing and distribution of the subscriber's credentials. The administration page may allow a subscriber to view a listing of third parties that have viewed the subscriber's credentials, establish a payment method, order additional reports, or upgrade the subscriber's membership to a higher level where more detailed reports are available. The administration page may also allow the subscriber to store comments on individual entries in the subscriber's profile and upload documents to provided further information on entries in the subscriber's profile. As an illustrative example, the subscriber may attach a note to an employment record describing a termination event that occurred with the employer.

As one having ordinary skill in the art would recognize, the PCS 100 allows a subscriber to provide credential information in a secure environment. Further, the subscriber can determine what information is viewable by third parties. On the lowest level, a third party may be able to view only an emblem representing the rating of the subscriber in different categories. On a higher level, the third party may view all information in the subscriber's profile. By providing the information on a secure web site that expires based on an expiration event, the threat of the subscriber's information being stolen is greatly reduced.

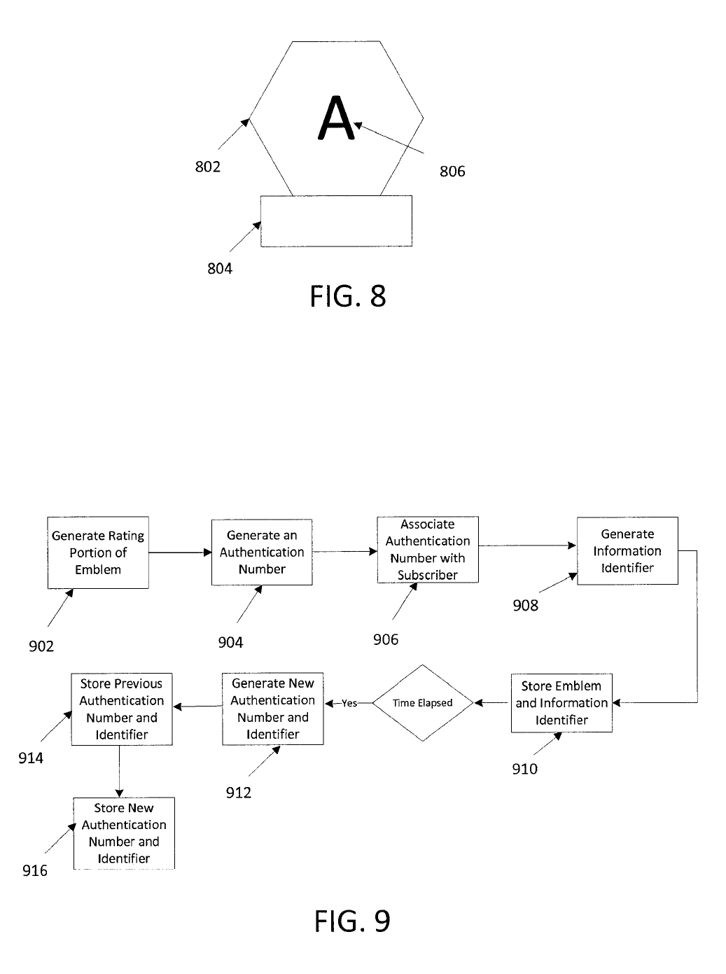

FIG. 8 depicts one embodiment of an emblem 800 that is consistent with the present invention. The emblem 800 includes a rating portion 802, an information identification portion 804 and a text identification portion 806. The rating portion may have a shape such as a ribbon shape, circular shape, elliptical shape or any other shape or size that can identify the rating portion as being associated with the subscriber. The information identification portion 804 may include a bar code, quick response code, or another icon used to confirm the authenticity of the emblem.

FIG. 9 depicts a schematic representation of a process used to generate an emblem 800. In step 902, the credential display unit 118 generates the rating portion of the emblem 800 using any of the rating information previously discussed. In step 904, the credential display unit 118 generates an authentication number or value. The authentication number can be a number or value uniquely assigned to the subscriber or a random number assigned to the subscriber. In step 906, the credential analysis unit 116 relates the authentication number to the subscriber account. In step 908, the credential display unit 118 generates an information identifier based on the authentication number. The information identifier may be a quick response code that is encoded with the subscriber's name, the authentication number and a URL where the subscriber's public information is available for viewing. In step 910, the emblem 800 and the information identifier portion are stored in the information storage unit 214 by the credential analysis unit 116. In step 912, after a predetermined time has elapsed, a new authentication number is generated for the subscriber by the credential analysis unit 116. In step 914, the previous authentication number and information identifier are stored in the information storage unit 214 by the credential analysis unit 116 along with a time and date stamp indicating the time when the information identifier and authentication number were generated. The credential analysis unit 116 may store a predetermined number or previous authentication numbers in the information storage device 214. The predetermined number may be based on a predetermined time period, such as a day, week or month. In step 916, the new authentication number and information identifier are stored in the information storage unit 214. The process of generating new authentication numbers and identifiers may continue indefinitely or may stop after a predefined number of changes.

As an illustrative example of the process disclosed in FIG. 9, a subscriber may have a random number initially assigned to the subscriber's account. The information display unit 118 may embed the random number into a quick response code along with the subscriber's name and a URL address where the subscriber's information can be viewed. An external web site, such as LinkedIn or Match.com, may display the subscriber's emblem along with the quick response code. When a user scans the quick response code using a mobile communication device, such as a smart phone, an application operating on the smart phone parses the quick response code and redirects the user to the subscriber's public page. Simultaneously, the application operating on the smart phone compares the authentication number embedded in the emblem with the listing of authentication numbers stored in the information storage unit 214.

If the authentication number scanned by the smart phone matches an authentication number, either an active authentication number or a prior authentication number, associated with the subscriber in the information storage unit 214, the user is granted access to the web page address embedded in the quick response code. If the authentication number in the emblem does not match an authentication number associated with the subscriber in the information storage unit 214, the credential analysis unit 116 identifies the emblem 800 as a counterfeit emblem and does not route the web page embedded in the quick response code. In addition, the application operating in the memory of the smart phone may record the phone number of the smart phone scanning the quick response code and store that information in the information storage unit 214.

In another embodiment, the credential display unit 118 may allow the subscriber to assign a smart phone device as an authentication smart phone device. The authentication smart phone device operates software that displays the emblem and updates the display when the emblem is updated. The application may also scan quick response codes of other subscriber's to authenticate other subscribers identities.

As an illustrative example, the application may allow two users meeting for the first time to scan respective quick response codes to confirm the identity of the other person. The application may scan the respective quick response code and compare the authentication number with the current authentication number assigned to the subscriber's account. If the authentication numbers match, the application may notify the subscriber of the match. If the authentication numbers do not match, the application may notify the user of the lack of a match.

As an additional step to confirm the identity of the other person, the credential display unit 118 may compare the smart phone number with the authentication phone number of a user to determine if the phone numbers match. If the phone numbers match, the application may indicate that the identity of the person is confirmed. If the phone number does not match, the application may notify the user of the authentication failure. The credential display unit 118 may also compare the phone number of the authentication device with known phone numbers of the subscriber to further verify the identity of the subscriber.

The information identifier may also be used to generate a request to view additional information on a subscriber. As an illustrative example, the subscriber's public information page may include a listing of information available for viewing by the public. An emblem having a second information identifier may be displayed on the subscriber's public information page. When a user scans the second emblem, the emblem is authenticated using the process listed above and the application operating in the memory of the smart phone may display a listing of information available for viewing for the subscriber. The application may transmit a view request to the subscriber describing the information the user would like to view. Upon approval of the request by the subscriber, the web page is generated and displayed using the processes described above and the user is directed to the newly created web page using any of the processes discussed herein. An emblem having a third identifier may be displayed on the third web page allowing the user to scan the information identifier to verify the authenticity of the web page using the authentication process previously discussed.

The following examples and use cases will further illustrate the operation and applications of the system and methods of the invention. Use of the system and methods of the invention can reduce or eliminate individuals' inaccurate self-reported personal information, and can address individuals' concerns with their personal and financial safety.

The personal credentialing system of the invention may be used as an add-on premium service to established online networks. The target markets have been segmented by the user base that applies to a respective profile (i.e. LinkedIn users may be interested in the service for the verification of information relevant to a business relationship). For this reason, the target markets for the invention may be described according to the source of information, realizing that several users may be active on multiple networks. The following short use cases are described for five specific distribution outlets: online networking—business relationships; online networking—personal relationships; professional recruiting; vacation property rentals; and on line commerce.

In the first case of online networking—business relationships, the system and method of the invention may be used to reduce or eliminate self-reported personal data misrepresentations, erroneous data provided by external sources, and negative personal representations of an individual consumer. For example, the invention may be used with the LinkedIn service. Key personal data elements can be verified by a FCRA compliant background screening services partner. The FCRA compliant service provider will verify the accuracy of standard data elements including name, current address, date of birth, criminal records, & education history. Optional verifiable data elements would include employment history, financial credit status, licenses & affiliations, and civil litigation records. Verified personal data may be highlighted within the individual's LinkedIn resume and a credentials certificate emblem may be attached to their profile. All records will be stored securely in the subscriber's account.

In the second case of on-line networking—personal relationships, such as on-line dating sites, the system and methods of the invention may reduce or eliminate self-reporting errors and omissions to provide a safer interpersonal experience. This is especially the case as individuals become more concerned about their personal and financial safety as their age and wealth increases. The opportunity for an individual to interact with a potential suitor is fraught with risk that can be significantly diminished by accurately investigating their personal data profile. A process to ensure that a credentialed subscriber is carefully screened from a suitor who does not provide accurate, verified personal data is a significant requirement.

In order to protect the subscriber and to generate significant new revenues, the system and methods of the invention may be used with an existing social networking site as a new, premium tiered service offering. For example, a three-tiered service might be structured as follows: Basic: Zero (0) stars: Business as usual—standard user and no data verifications; Tier 1: One (1) star: Verify name, current address, address history, date of birth, & sex offender lists; and Tier 2: Two (2) stars: Verify criminal records & civil litigation history and credit score and Tier 1 data verifications. A credentials user will have the ability to limit access to their records. The Tier 2 user will be able to view all Tier 0, Tier 1, and Tier 2 profiles. A Tier 1 user will be able to interact with Tier 1 and Tier 0 only. Tier 0 users will have access to only other Tier 0 profiles. From a personal safety perspective, the existence of a tiered service provides protection for both the subscriber and dating web site. Individuals will use the services to screen potential suitors. The social networking web site will provide its members a voluntary, for-a-fee service that creates a safety net to minimize dangerous encounters and limit the web site's legal exposure.

In the third case of professional recruiting, the system and methods of the invention may help ensure that the individual's resume includes certified credentialed personal data. Currently, resumes are self-reported and easily misrepresented. A HireRight study (2012) estimated that one-third of all resumes contain at least one misrepresentation.

In the fourth case of vacation property rentals, the system and method of the invention may be used to create a certified personal data profile for each individual consumer to eliminate fraudulent transactions and to streamline the approval process. This is especially true for online rental services such as VRBO (Vacation Rentals by Owner) and Home Away, where it is not currently possible to verify a user's identity. Key personal data elements can be verified by a FCRA compliant technology services partner. The FCRA compliant system will verify the accuracy of standard data elements including name, current address, date of birth, criminal records, & credit status. Verified personal data will be highlighted within the subscriber's profile and a Credentials Certificate emblem will be attached. All records will be stored securely in the subscriber's account. Both the prospective home renter and potential renters will benefit from having a pre-verified credentials profile stored and available for review. Further investigation will not be a requirement to ensure safe, financial capable renters.

In the fifth case, on-line commerce, the system and methods of the invention may be used to develop a consistent buyer and seller credentialing process to facilitate transactions between individuals that do not know each other. This is especially true in on-line marketplaces such as Craigslist & eBay. An incredible number of retail transactions occur between individuals who use the Internet to research and find products and services that are of interest to them. Little verification is possible between the individuals and most transactions are completed on blind faith that the purchaser will provide the product purchased and that the buyer will actually send the funds to complete the transaction. The personal credentialing of the invention will provide a common network for individuals to have confidence that the transaction will be completed by the other party. In addition, by combining the credentialing process with a payment processing system (e.g., PayPal) will streamline and improve the integrity of the person to person purchase transaction environment.

The system of the invention may be implemented in a number of ways to enhance the user experience. For example, a new credentialing user preferably will have two options to create his initial profile. He may complete an on-line application profile using a web-based credentialing interface. Once the individual is able to pass through the identity and verification process he will be provided a menu to make his personal data element selections. In the alternative, the credentials user may complete the verification and authentication process through a URL from any web site where he already has a stored profile. Once authorized, the user will be permitted to export his verified, credentialed personal information and credentials certificate to any trusted, secure credentialing business partner through his unique assigned URL.

Each subscriber will receive a unique, portable certificate emblem and URL that will be displayed on any web site that permits it to be present in the subscriber's profile. The emblem and URL are generated in conjunction with the FCRA service provider and will include industry standard verification for all personal data and FCRA records.

Credentialed subscribers will likely want to display their verified emblem and URL in connection with multiple web based service providers. Examples would include LinkedIn, Home Away, social networking, and/or on-line commerce web sites. Each site will be linked to the FCRA service partner through the service provider to verify the individual's logon information and allow data distribution at the subscriber's discretion.

The use of verified data is the only method to eliminate self-reported data errors and omission. FCRA data records and other verified information provide the best possible protection against fraudulent personal records.

The protection of a subscriber's verified personal information is more critical than self-reported data, because it is extremely accurate and valuable to those who would purloin a person's identity. Extreme care must be given to ensure the credentialing system has a solid user verification and authentication process in place. The need to verify an individual is who they say they are is a system cornerstone and requires strong user passwords (with random updates/changes) plus unique out of wallet challenge questions for every potential system access.

The data repository of the system preferably provides a unique “information vault” for each subscriber that provides security and absolute privacy from outside threats.

The ability to differentiate the severity of criminal and credit records is an important aspect of an individual's profile. A straightforward color schema (green, yellow, red) can provide a clear differentiation of a subscriber's status for both criminal and credit history. For example, criminal records may be distinguished as Red: records present for thievery, financial misdeeds, violence, sexual offenses, and/or other felonies; Yellow: Records present for misdemeanors, DUI, and/or non-felonies; and Green: Clear record. A credit score may be marked as, for example, Red <550; Yellow, 551-700; and Green >700.

The invention may also be advantageously used to prevent persons from posting fraudulent information online. As described above, the system and method may be used for verifying the identity and credentials of a person who desires to post information by gathering initial information about the person; gathering additional information pertaining to the person based on the initial information; and categorizing the additional information based on predefined criteria. Then, a score may be assigned to the additional information based on criteria including the categorization of the additional information. Thereafter the person may be permitted to post the information only if the score exceeds a predefined threshold value. This provides a level of confidence that the person is who he claims to be, and that the information is accurate. The permitting may occur before or after an initial or subsequent posting, and if the criteria are not met (i.e., the score is insufficient) the posting is not permitted, or a provisional or tentative posting may be removed. Of course, “person” as used herein may be a natural person or a non-natural entity, such as, for example, a corporation, partnership, LLC or other entity.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

1. A personal credentialing system comprising:
an information gathering unit that gathers information from a subscriber;
a credential analysis unit configured to
(a) gather additional information pertaining to the subscriber based on the information gathered by the information gathering unit,
(b) store the additional information in a storage unit,
(c) categorize the additional information based on predefined criteria,
(d) assign an indicator to the additional information based on categorization and representative value of the additional information, and
(e) store the additional information and indicators in the storage unit;
a credential access unit that receives requests for access to view the indicators and stored additional information from a third party; and
a credential display unit that displays the indicators and stored additional information on a web page after the credential access unit authorizes a request to view the stored additional information.

2. The personal credentialing system of claim 1, wherein the stored additional information is prevented from being displayed on the web page after the expiration of a predetermined event.

3. The personal credentialing system of claim 2, wherein the predetermined event is the elapse of a predetermined time period.

4. The personal credentialing system of claim 2, wherein the predetermined event is the viewing of the web page by the third party.

5. The personal credentialing system of claim 1, wherein the subscriber selects the information displayed on the web page based on the third party request.

6. The personal credentialing system of claim 1, wherein the credential analysis unit categorizes the additional information as FCRA compliant or non FCRA compliant.

7. The personal credentialing system of claim 1, wherein the credential access unit transmits a request to authorize the viewing of the stored additional information to the subscriber.

8. The personal credentialing system of claim 7, wherein the credential access unit grants access or denies access to the stored additional information based on the subscriber's response to the transmitted request.

9. The personal credentialing system of claim 7, wherein the request includes a listing of the stored additional information, and the response to the request includes a listing of information the third party is authorized to view.

10. The personal credentialing system of claim 1, wherein the indicator is a color coded emblem.

11. A system of conveying personal credential information stored on a device having a memory and a processor, the device having a program executed in the memory that performs the steps of:
gathering information from a subscriber by an information gathering unit;
gathering by a credential analysis unit additional information pertaining to the subscriber based on the information gathered by the information gathering unit,
storing by the credential analysis unit the additional information in a storage unit in the memory,
categorizing by the credential analysis unit the additional information based on predefined criteria,
assigning by the credential analysis unit an indicator to the additional information based on categorization of the additional information, and
storing by the credential analysis unit the additional information and indicators;
receiving requests by a credential access unit for access to view the indicators and stored additional information from a third party; and
displaying by a credential display unit the indicators and stored additional
information on a web page after the credential access unit authorizes a request to view the stored additional information.

12. The system of claim 11, wherein the stored additional information is prevented from being displayed on the web page after the expiration of a predetermined event.

13. The system of claim 11, wherein the subscriber selects the information displayed on the web page based on the third party request.

14. The system of claim 12, wherein the predetermined event is the elapse of a predetermined time period.

15. The system of claim 12, wherein the predetermined event is the viewing of the web page by the third party.

16. The system of claim 11, wherein the credential analysis unit categorizes the additional information as FCRA complaint or non FCRA compliant.

17. The system of claim 11, wherein the credential access unit transmits a request to authorize the viewing of the stored additional information to the subscriber.

18. The system of claim 17, wherein the credential access unit grants access or denies access to the stored additional information based on the subscriber's response to the transmitted request.

19. The system of claim 17, wherein the request includes a listing of the stored additional information, and the response to the request includes a listing of information the third party is authorized to view.

20. The system of claim 11, wherein the indicator is a color coded emblem.

21. A method for verifying an individual's personal credentials comprising:
gathering initial information from a subscriber;
gathering additional information pertaining to the subscriber based on the initial information,
storing the additional information in a storage unit,
categorizing the additional information based on predefined criteria,
assigning an indicator to the additional information based on the categorization and representative value of the additional information, and
storing the additional information and indicators in the storage unit;
receiving a request for access to view the indicators and stored additional information from a third party;
authorizing a request to view the stored additional information; and
displaying the indicators and stored additional information on a web page.

22. A method of creating and conveying personal credential information stored on a device having a memory and a processor, comprising executing by the processor a program stored in the memory to perform the steps of:
gathering initial information from a subscriber;
gathering additional information pertaining to the subscriber based on the initial information,
storing the additional information in a storage unit in the memory,
categorizing the additional information based on predefined criteria,
assigning an indicator to the additional information based on the categorization of the additional information,
storing the additional information and indicators;
receiving a request to view the indicators and stored additional information from a third party; and
displaying the indicators and stored additional information on a web page after authorizing a request to view the stored additional information.

23. The method of claim 22 further comprising the steps of:
generating by the processor an authentication value;
relating the authentication value to the subscriber's account;
generating an information identifier based on the authentication value;
storing the indicator and the information identifier in the memory together with a time and date information indicating when the information identifier and authentication value were generated;
after a predetermined time, generating a new authentication value and new information identifier; and
storing the new authentication value and the new information identifier in the memory.

24. The method of claim 23 wherein the information identifier is a quick response code encoded with the subscriber's name, the authentication value and a URL where the subscriber's public information is available for viewing.

25. The method of claim 24 further comprising receiving from the subscriber a designation of a personal electronic device as an authentication personal electronic device, transmitting from the device to the authentication personal electronic device the indicator and the information identifier.

26. The method of claim 25 wherein the authentication electronic device is a smart phone, further comprising comparing, by the processor, the phone number of the smart phone with a phone number of the subscriber stored in the memory to verify the identity of the subscriber.

27. The method of claim 24 further comprising:
receiving at the device a request for information based on a scan of the quick response code,
in response to the request, comparing the authentication value encoded in the quick response code with the current authentication value stored in the memory; and
sending from the device to the authentication electronic device an indication based on the comparing of whether the authentication values match or do not match.

28. A method for preventing fraudulent online postings by a person comprising:
verifying the identity and credentials of the person by executing with a processor a program stored in a computer memory the following:
(a) gathering initial information about the person;
(b) gathering additional information pertaining to the person based on the initial information;
(c) categorizing the additional information based on predefined criteria; and
(d) assigning a score to the additional information based on the categorization of the additional information; and
thereafter permitting the person to post the information if the score exceeds a predefined threshold value.
